(19) United States
(12) Patent Application Publication
(10) Pub. No.: US 2012/0080143 A1
(43) Pub. Date: Apr. 5, 2012

(54) GUARANTEE SEAL WITH PULL-TAB FOR CONTAINERS AND A METHOD OF MANUFACTURE

(75) Inventors: Jose Manuel Gonzalez Carro, Tlalnepantla (MX); Paulo Gonzalez Carro, Tlalnepantla (MX); Andrew Gonzalez Dodd, Tlalnepantla (MX)

(73) Assignee: LAMINADOS FACARLYTE, S.A. DE C.V., Tlalnepantla (MX)

(21) Appl. No.: 13/314,936

(22) Filed: Dec. 8, 2011

Related U.S. Application Data
(62) Division of application No. 12/471,264, filed on May 22, 2009.

(30) Foreign Application Priority Data
Feb. 27, 2009 (MX) MX/A/2009/002244

(51) Int. Cl. B32B 38/04; B29C 47/06; B32B 37/02

(52) U.S. Cl. 156/244.19; 156/250

(57) ABSTRACT

A method of manufacturing a guarantee seal with a pull tab for containers includes applying adhesive to a polymeric film in intermittent strips, laminating the polymeric film with the adhesive in intermittent strips to a second film, the second film including an EPE or PE layer, an aluminium foil layer and a sealing substrate to obtain a laminated film with strips of adhesive and strips without adhesive, die cutting the laminated film to form cut bands in the shape of circles so that a first side of the circle has the strip with adhesive and a second side of the circle has the strip without adhesive.

### CROSS-REFERENCE TO RELATED APPLICATIONS

The present application is a divisional application of U.S. patent application Ser. No. 12/471,264, filed on May 22, 2009, entitled “Guarantee Seal with Pull-Tab for Containers and a Method of Manufacture,” which claims the benefit of Mexican Patent Application No. MX/a/2009/002244 filed Feb. 27, 2009, entitled “Sello De Garantia Con Lengueta Para Envases Y Su Metodo De Manufatura,” which is hereby incorporated by reference in its entirety.

### BACKGROUND OF THE INVENTION

1. The Field of the Invention

The present invention relates to containers such as vials, bottles, and the like for nutritional, pharmaceuticals, and other containers and to a guarantee seal with a pull tab for use with such containers, and a method of manufacture.

2. Relevant Technology

Guarantee seals provide protection for products contained within containers. Often, guarantee seals make use of several seal layers, including polymers such as PET, PE, PP, EVA, PVC and other materials that are joined to substrates such as aluminium, paper or cardboard, etc.

Guarantee seals can include several types of pull tabs that provide for removal of the guarantee seal from the container. One type of pull tab is a radial extension of the seal that is formed when the sealed material is cut with a specialized die cutter to include a pull tab. Such seals can contain more than one pull tab and the dimensions and shape of the pull tabs depend on the design of the die cutter. Another type of the seal with a pull tab contains the pull tab incorporated at the top of the seal and the use of a specialized die cutter can often be omitted during manufacture.

A process of manufacturing a guarantee seal in which the radial extension pull tab is part of the seal can be complicated by requiring the use of a specialized cutting die that includes the radial extension. Such an approval can also involve the complicated folding of the pull tab which tends to straighten due to the memory of the structure of the seal. This complication may require additional equipment to avoid or minimize the unfolding of the pull tab. Moreover this kind of seal can complicate the flow of heat associated with sealing the seal with respect to the container. For example, heat can flow around the perimeter of the seal, including the radial extension of the tab, thereby potentially causing the thermosealant of the pull tab to be activated by the heat of the induction and to adhere to the neck of the cap.

Accordingly, the manufacturing processes of seals with incorporated pull tabs are often complicated and/or involve a lot of resources. Various techniques have been undertaken to overcome these complications. For example, one approach provides a seal that includes a membrane that contains a thermosealant in its outer face and a non-laminable layer. The seal also includes a top layer capable of adhering to the membrane and the non-laminable layer. This structure is die cut in such a manner that the resulting disc or seal contains a portion of the non-laminable layer and one portion which lacks of such non laminable layer.

One disadvantage of this kind of structure is the thickness difference in the seal profile since the portion which contains the non-laminable layer is thicker than the portion which lacks the non-laminable layer. Such a difference may cause deficient contact between the seal and the mouth of the container causing a faulty seal, particularly in the immediately area of the interface.

Further complications can arise due to the difference in the profile of heat absorption in the sealing process between the part which contains the non-laminable layer and the portion which lacks the non-laminable layer. In particular, since the portion which contains the non-laminable layer has more mass, it will absorb more heat than the portion which the other layer in the sealing process resulting non-uniform heating between the two portions of the seal, thus contributing to faulty sealing.

Another approach makes use of a seal composed for a first lamination which includes an aluminium layer and a thermosealant layer and a second lamination which includes a film or plastic foam and one PET layer (Polyethylene terephthalate). These two laminations are joined by a layer of adhesive and also includes one section having a dotted pattern. The structure is die cut in such a way that the resulting disc covers a solid portion and a dotted portion of the adhesive.

One deficiency of such an consists in that the dotted portion of the seal which must form the pull tab is not positively separate, besides that such portion may be difficult to identify and separate by the consumer.

The subject matter claimed herein is not limited to embodiments that solve any disadvantages or that operate only in environments such as those described above. Rather, this background is only provided to illustrate one exemplary technology area where some examples described herein may be practiced.

### BRIEF SUMMARY OF THE INVENTION

A method of manufacturing a guarantee seal with a pull tab for containers includes applying adhesive to a polymeric film in intermittent strips, laminating the polymeric film with the adhesive in intermittent strips to a second film, the second film including an EPE or PE layer, an aluminium foil layer and a sealing substrate to obtain a laminated film with strips of adhesive and strips without adhesive, die cutting the laminated film to form cut bands in the shape of circles so that a first side of the circle has the strip with adhesive and a second side of the circle has the strip without adhesive.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a step for applying adhesive to a polymeric film with the use of rollers according to one example;

FIG. 2 illustrates a step for the splicing of the polymeric film to a second film according to one example;

FIG. 3 illustrates a method of joining a polymeric film to a second film with an extruded material according to one example;

FIG. 4A illustrates a first step of cutting cut bands according to one example;

FIG. 4B illustrates a cut band according to one example;

FIG. 5A illustrates a step for cutting patterns from a cut band according to one example;

FIG. 5B illustrates a guarantee seal according to one example;

FIG. 6A illustrates a first step of cutting cut bands according to one example;

FIG. 6B illustrates a cut band according to one example;

FIG. 7A illustrates a step for cutting patterns from a cut band according to one example;

FIG. 7B illustrates a guarantee seal according to one example; and

FIG. 8 illustrates a guarantee seal with a pull tab according to one example.

### DETAILED DESCRIPTION OF THE PREFERRED EMBODIMENTS

A guarantee seal and method manufacture are provided herein. The guarantee seal and a guarantee seal produced by the method provide a pull tab that does not include adhesive. Such a configuration can result in a pull that is positively separated from the rest of the guarantee seal, is easy to locate and identify and thus easy to use for consumers.

Further in at least one example, an exemplary method described below the guarantee seal can reduce or eliminate the use of a die cutter that includes a pattern with a pull tab incorporated therein. Such a configuration can thereby reduce the likelihood that a folded pull tab will become folded due to the memory of the material. Such a configuration can also reduce potential adhesion of the pull-tab to the inside of the cap as well as potential problems of the heat distribution used to seal a guarantee seal to a container.

In at least one example, a guarantee seal does not contain a non-laminable layer, thereby allowing the profile of the seal thickness to be substantially uniform, thus ensuring an sufficient contact between the seal and the mouth of the bottle. At the same time, the absence of the non-laminable layer can help ensure a better distribution of the heat of sealing.

Reference will be made in detail to examples illustrated Figures. The same reference numbers in the drawings and the description refer to similar, though not necessarily, the same components.

The next description is presented to enable someone with skill in the art to make and use the present invention, and is provided in the context of a patent application and its requirements. Several modifications to the described embodiments will be apparent to those with skill in the art and generic principles taught in the same may be applied to other embodiments. In this way, the present invention is not intended to limit to the shown embodiment but remember the wider range consistent with the principles and features described herein including alternatives, modifications and equivalents, as defined within the range of the attached claims. The drawings are necessarily not in scale and may be of a schematic nature. The descriptive terminology has been adopted with the purpose of improving the comprehension of the reader, respect to the several views provided in the figures, and it does not pretend being limiting.

By way of introduction, several steps are shown that are part of a method of manufacturing a guarantee seal. As will be described in more detail below, the method includes splicing, laminating, adhering, or otherwise securing or joining a polymeric upper layer and a lower film that includes a sealing substrate to form a precursor sheet. The precursor sheet is formed such that bands, strips or other intermittent patterns of adhesive are formed such that one region of the upper polymeric film is secured to the lower film and an adjacent, alternate region is not secured to the lower film.

Guarantee seals can then be cut from the precursor sheet by cutting a pattern that includes part of the region of the precursor sheet in which the upper polymeric film is secured to the lower film and part of the region of the precursor sheet in which the upper polymeric film is not secured to the lower film. In such an example, the non-secured portion is free from the lower film and can thus serve as a pull tab. In at least one example, an intermediate step can be utilized in which the precursor sheet is cut into cut bands and then subsequently die cut to form the guarantee seals, though it will be appreciated that such an intermediate step can optionally be omitted.

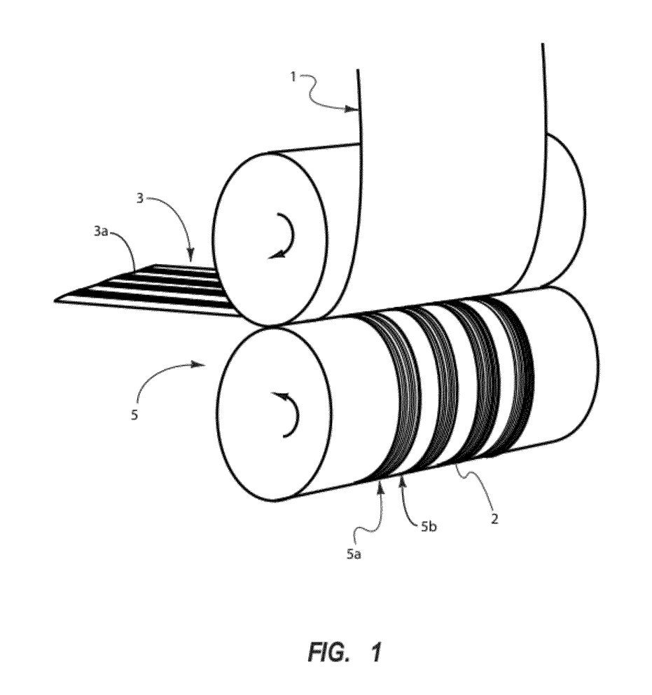

FIG. 1 illustrates a first step for forming a guarantee seal according to one example. In particular, FIG. 1 illustrates a lamination step in which strips of adhesive 2 are impressed to a polymeric film 1 with the help of rollers 5 resulting in the laminated layer 3 with adhesive strips 3a.

Typical rollers are often uniform from end to end. Such a configuration can allow such a roller to consistently and uniformly apply an amount of adhesive to a substrate from side to side. However, in the present example the roller 5 can be configured as a rotogravurer roller to apply the adhesive in strips, containing application areas and non-application areas which can be provided due to differences in the profile of the roller 5.

Application areas 5a of the roller 5 can include a recess defined in the lower roller, such as the types of recesses commonly used in rotogravurer rollers. Non-application areas 5a on the roller 5 can smooth and free of recesses. The bottom of the roller 5 can be immersed in the tray which contains the adhesive. The excess of adhesive can be removed by a roller blade.

The recesses associated with the application areas 5a are filled with the adhesive and the non-application areas 5b are substantially devoid of the adhesives 2 As the roller 5 contacts the polymeric film 1, the adhesive in the recesses in the application areas 5a is transferred to the polymeric film 1 in form of longitudinal strips 3a.

In at least one example, before the adhesive is applied to the substrate, the adhesive can be pigmented with a colorant so that the lamination layers are distinguished from non-lamination layers. Depending of the resistance of the polymeric film 1, this may be reinforced with many substrates; which can include, but are not limited to, a PE polyethylene layer, BOPP oriented polypropylene, nylon, etc. While the application is described in the context of rollers configured as rotogravurer type rollers configured to apply the adhesive in strips, it will be appreciated that any number of impression, transfer, or other techniques can be used to apply strips of adhesive to one portion of a polymeric film while leaving other, adjacent portions devoid of adhesive. Such methods can include, without limitation, other impression means as the flexography printing or other application methods.

The polymeric film 1 with the adhesive in strips, which will be pigmented if the adhesive was previously pigmented, can act as an upper portion or top of a precursor sheet 6 as shown in FIG. 2. An additional step can occur in parallel to the formation of the film 3 with longitudinal adhesive strips 3a. Such a step can include the formation of a lower portion or bottom of the guarantee seal, which can include a film 4. In at least one example, the film 4 can be formed through or include one or more laminations having an expanded polyethylene layer (EPE) or in its place, a polyethylene film (PE) as well as an aluminium foil layer and a sealing substrates such as a thermosealant layer.

In at least one example, the film 4 can include, in order 1 form inside outward, (EPE or PE layer 2) a metallic foil, such as aluminium foil, and 3) a thermosealant. If EPE expended polyethylene is used, it may be joined to the aluminium by adhesive or laminated by extrusion. The thermosealant layer may be extruded over the aluminium or if it is a PET film, it can be re-covered with a thermosealant layer. Such a film can be laminated by adhesive or by extrusion to the aluminium layer.

EPE can be used when more body is desired, such as for guarantee seals in which greater padding is desired to ensure sufficient contact between the guarantee seal and the mouth of a container. PE can be used when the padding is not desired or to give less thickness to the guarantee seal, which can help improve the heat distribution during the sealing process, thus obtaining a lower cost structure.

FIG. 2 illustrates a second step of a lamination method that includes splicing of the polymeric film 1, to the film 4 to form a precursor sheet 6 that is subsequently processed to form a body of a guarantee seal. The layers 3 and films 1 and 4 can be joined by the longitudinal strips 3a. In the illustrated example, a set of lamination rollers 8 passes the film 1 to the film 4. Such a process leaves spaces between the strips without adhesive, in such a way that the films 1 and 4 stay strongly laminated in the areas with adhesive and stay un-laminated in the areas that lack adhesive.

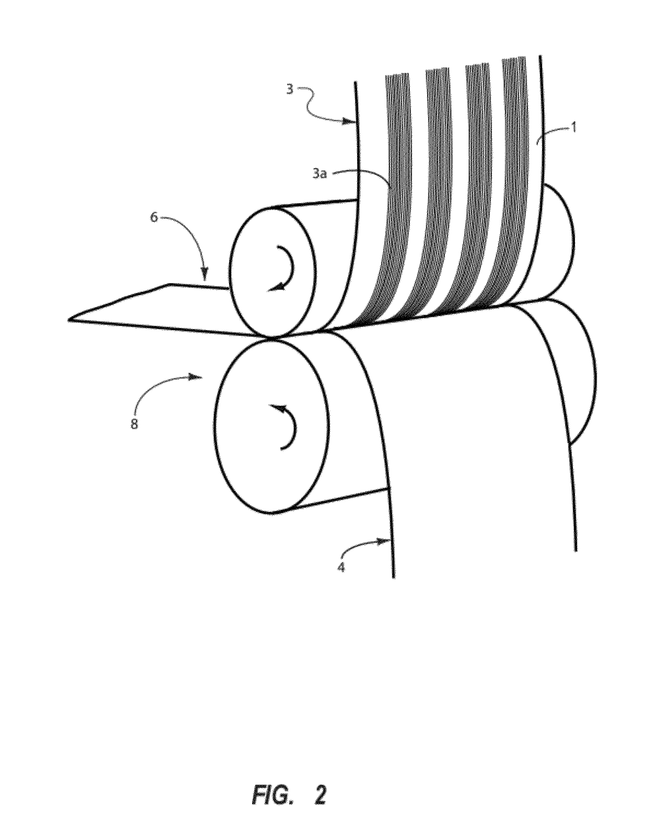

FIG. 3 illustrates another exemplary method that includes an extrusion step to join or couple films 1 and 4 with a polymer that serves as an adhesive. With the use of an extrusion machine such as is illustrated in FIG. 3, a first roller 30 provides a polymeric film 1 to the lamination system by extrusion feeding to a nip point, which can be described as a point of convergence between two rolling parts. In the illustrated example, the polymeric film 1 is directed to a nip point or nip points between rollers of roller assembly 10. At the same time, on the opposite side of the extrusion machine is film 4, which is directed by accompanying rollers toward a to the nip point an upper pair of roller assembly 10. As a result, film 1 and film 4 are joined at the nip point between the roller assembly 10. In addition, a third material 9a is fed to the nip point between rollers 10 by extrusion machine 9. The material 9a serves as an adhesive to join the films 1 and 4 where the material contacts both films 1 and 4. In particular, the third material 9a is extruded to form strips that are deposited and joined between the two films 1 and 4 at the nip point between rollers 10. As a result, the strips of material 9a cause some portions of the films 1 and 4 to be adhered together and other portions to not be adhered together, thereby forming a precursor sheet 6′.

The polymeric film 1 described can subsequently be the substrate of the pull tab of the guarantee seal. In at least one example, the extruded material 9a which serves as adhesive can be pigmented beforehand to cause the extended material 9a to be visible relative to the polymeric film 1 and therefore easily distinguishable.

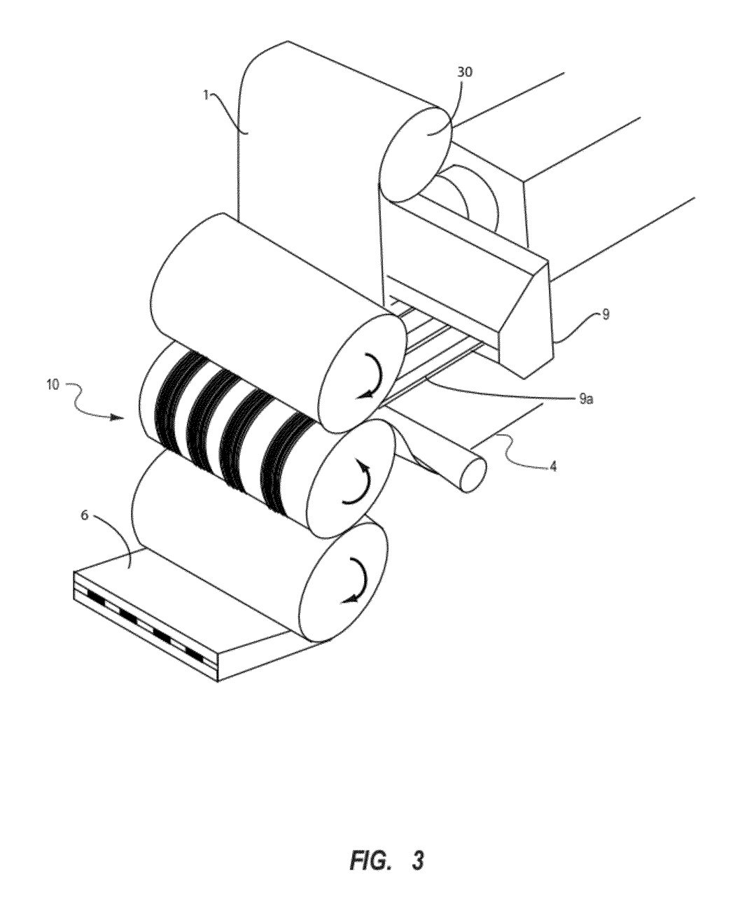

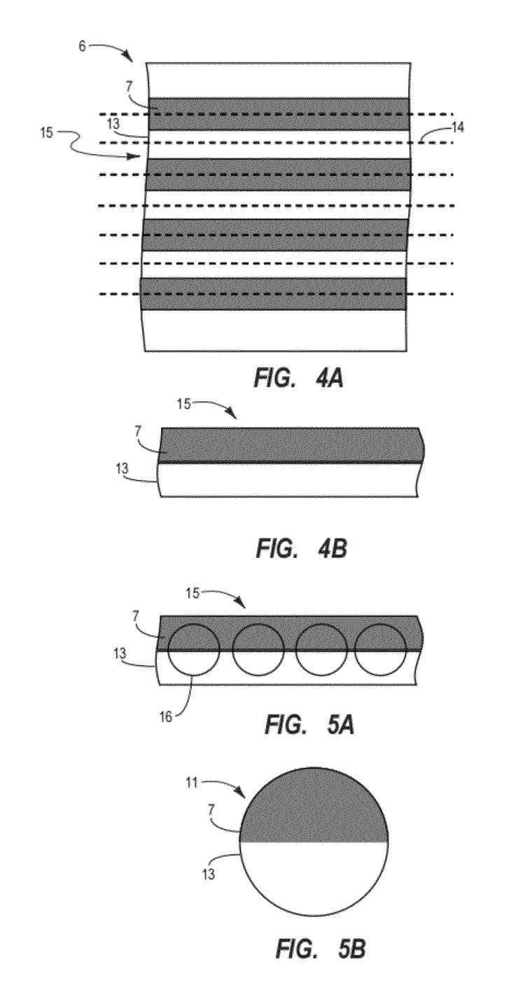

FIG. 4A illustrates a precursor sheet 6 resulting from the complete splicing of the layers and the adhesive which form the body of a guarantee seal either through the lamination process by adhesives (impression) or by a lamination process through extrusion, which includes at least a strip with adhesive 7 and a strip without adhesive 13.

The resulting precursor sheet 6 is cut in longitudinal lines shown by cut lines 14. As shown in FIGS. 4A and 4B, the cut lines 14 form cut bands 15 that include one portion of a strip of film with adhesive 7 and one portion 13 of a strip without adhesive. Such a configuration can facilitate a simple die cut. In particular, the reel or cut bands 15 can be die cut in such a manner that each includes a laminated portion 7 and a portion that is not laminated 13. The non-laminated portion 13 provides a pull tab in form of crescent which will be used to pull and easily remove a guarantee seal from the mouth of a container.

In particular, FIG. 5A illustrates patterns that are die cut or other cut from the cut bands 15. In the illustrated example, the patterns are in the form of circles 16, one of which is illustrated in a complete and finished form in FIG. 5B to form a guarantee seal″.

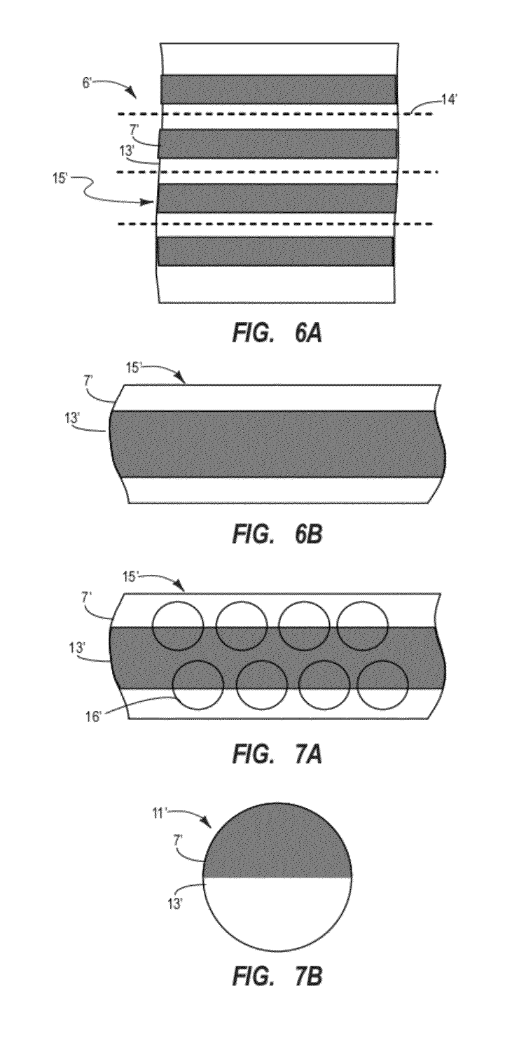

FIG. 6A illustrates the precursor sheet 6′ resulting of the complete splice of the layers and the adhesive which form a body of a guarantee seal. The precursor sheet 6′ can be divided with longitudinal lines shown as cut lines 14′ to form cut bands 15′, shown in FIG. 6B, having a central strip 7′ having an adhesive and a lateral portions without adhesive 13′. Such a configuration can facilitate a strip that can be double die cut.

A double die cut pattern is illustrated in FIG. 7A, which shows the reel or cut band 15′ with patterns or cuts that are die cut in the form of circles 16′ in two parallel lines, which indicate the pattern that is cut from the cut bands 15′ to form a guarantee seal′″ having a lift tab that is adhered one side and not adhered on an opposing side as shown in FIG. 7b.

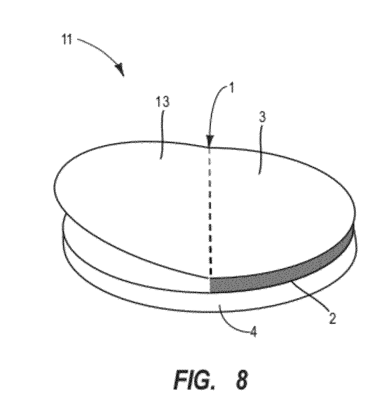

Finally, FIG. 8 illustrates a finished guarantee seal 11 having a pull tab formed from a portion of a polymeric film 1 in which one portion 3 is secured to a film 4 with adhesive and another portion 13 is not adhered to the film 4, accordingly, the unsecured portion 13 acts as pull tab. In at least one example, film 4 forms a substrate of support or body of the guarantee seal 11. The film 4 can include a EPE or PE layer, an aluminium foil and one thermosealant. An adhesive strip 7 can be applied between the films 1, 4 through any suitable process, such as by impression or by extrusion in the lateral part of the guarantee seal. The adhered portion 3 of the polymeric film 1 can be secured by impression or extrusion to the associated adhesive strip 7. Accordingly, an outgoing part of the same polymeric film 1 that is not adhered to the film 4 forms the pull tab 1) of the guarantee seal 11.

After the guarantee seal 11 with the pull tab 17 has been formed according to the referred methods, the guarantee seal 11 can be adhered to a mouth of a container by activating the thermosealant layer of the bottom of film 4 either by direct heat, conduction, indirect heat, or induction. In one example a conduction method can be used in the sealing process in which direct heat is applied to the guarantee seal 11, locating it on the mouth of the container with the thermosealant layer in contact with the mouth of the container. The direct heat applied activates the thermosealant adhesive to thus adhere the guarantee seal 11 to the mouth of the container.

In one example induction method can be used in the sealing process where the heat is induced by a magnetic field. The seal is located in a screw cap with the thermosealant layer towards the outside of the screw cap. The screw cap is then screwed in the neck of the container to place the thermosealant layer in contact with the mouth of the container and between the cap. The container is exposed to a magnetic field created by a machine known in the art as induction machine or sealer. The magnetic field creates an electric current in the aluminium of the seal, which causes the heating of this layer, thereby activating the thermosealant adhesive thereby adhering the guarantee seal 11 to the mouth of the container.

Due to the methods of manufacture of the guarantee seal with pull tab according with the embodiments of the present invention, the methods of adhering the seal to the container either by induction or conduction can facilitate handling, achieving a sealed with out deficiencies.

In at least one example, a method for adhering the guarantee seal with pull tab to the container may be done by replacing the thermosealant layer with another substrate, such as paper, where the sealing process a cold process in that the process can occur without the application of heat. In such an example, the seal would be achieved by the application of an adhesive to the mouth of the container. The guarantee seal would then be located in a screw cap with the paper towards the outside of the guarantee seal. The cap would then be screwed into engagement with the neck of the container to place the paper in contact with the adhesive applied to the mouth of the container thereby sealing the container.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of manufacturing a guarantee seal with a pull tab for containers, the method comprising:
applying adhesive by impression to a polymeric film in intermittent strips with rollers;
laminating the polymeric film with adhesive in intermittent strips to a second film, the second film including an EPE or PE layer, an aluminium foil layer and a sealing substrate to obtain a laminated film with strips of adhesive and strips without adhesive; and
die cutting the laminated film to form cut bands in the shape of circles so that a first side of the circle has the strip with adhesive and a second side of the circle has the strip without adhesive.

2. The method of claim 1, wherein applying adhesive by impression to a polymeric film in intermittent strips with rollers includes applying adhesive by impression to a polymeric film in intermittent strips with rollers in which the rollers have recesses defined therein to provide application areas and non-recessed areas to define non-application areas.

3. The method of claim 2, further comprising applying a colorant to the adhesive prior to applying the adhesive by impression.

4. The method of claim 2, wherein applying adhesive by impression to a polymeric film in intermittent strips with rollers in which the rollers have recesses defined therein to provide application areas and non-recessed areas to define non-application areas includes maintaining the recesses associated with the application areas filled with adhesive and the non-application areas substantially free of adhesive.

5. The method of claim 4, wherein applying adhesive by impression to a polymeric film in intermittent strips with rollers in which the rollers have recesses defined therein to provide application areas and non-recessed areas to define non-application areas including forming longitudinal strips of adhesive on the polymeric film.

6. The method of claim 1, wherein the sealing substrate is thermosealant.

7. The method of claim 1, wherein the sealing substrate is paper.

8. A method of manufacturing a guarantee seal with a pull tab for containers, the method comprising:
feeding a polymeric film to a roller assembly;
feeding a second film to a roller assembly, the second film including an EPE or PE layer, an aluminium foil layer and a sealing substrate,
extruding an extruded material between the polymeric film and the second film adjacent the roller assembly;
rolling the polymeric film, the second film, and the extruded material between rollers to obtain a laminated film with strips of adhesive and strips without adhesive; and
die cutting the laminated film with strips of adhesive in form of circles so that a first side of the circle has the strip with adhesive and a second opposing side of the circle has the strip without adhesive.
